(19) United States
(12) Patent Application Publication
(10) Pub. No.: US 2011/0185929 A1
(43) Pub. Date: Aug. 4, 2011

(54) INK METERING DEVICE OF A PRINTING PRESS

(75) Inventor: Martin Mayer, Ladenburg (DE)

(73) Assignee: HEIDELBERGER DRUCKMASCHINEN AKTIENGESELLSCHAFT, Heidelberg (DE)

(21) Appl. No.: 13/018,799

(22) Filed: Feb. 1, 2011

(30) Foreign Application Priority Data
Feb. 1, 2010 (DE) 10 2010 006 399.1

(51) Int. Cl. B41F 31/04

(52) U.S. Cl. 101/350.6

(57) ABSTRACT

An ink metering device for a printing press, providing improved handling of an ink fountain foil and reduced set-up times, includes an ink fountain for ink, an ink fountain roller rotating about an axis and dipping into the ink fountain, a plurality of zonal metering elements having blade edges at an adjustable distance from a circumferential surface of the roller, and at least one foil between the blade edges and the circumferential surface. The foil is fixed to the ink fountain and angled on one end along a straight line parallel to the axis. The ink fountain is to be thrown on and thrown off the roller between an operating position and a foil exchange position. The foil has a bend or curve so that when the ink fountain is thrown on, a foil end facing the roller is located substantially tangential with the circumferential surface before reaching an operating position.

### CROSS-REFERENCE TO RELATED APPLICATION

This application claims the priority, under 35 U.S.C. §119, of German Patent Application DE 10 2010 006 399.1, filed Feb. 1, 2010; the prior application is herewith incorporated by reference in its entirety.

### BACKGROUND OF THE INVENTION

1. Field of the Invention:

The invention relates to an ink metering device for a printing press, including an ink fountain containing a supply of printing ink, an ink fountain roller supported in side walls for rotation about an axis of rotation and for dipping into the ink fountain, a plurality of metering elements operating in zones and each having a blade edge disposed at an adjustable distance from a circumferential surface of the ink fountain roller and at least one foil disposed between the blade edges and the circumferential surface. The foil is fixed to the ink fountain and angled at least at one end along at least one straight line parallel to the axis of rotation, and the ink fountain is to be thrown on and thrown off the ink fountain roller between an operating position and an exchange position for exchanging the foil.

German Published Patent Application DE 32 03 500 A1, corresponding to U.S. Pat. No. 4,495,864, discloses an ink fountain including ink blades that are each equipped with a scraping edge. A distance between a respective scraping edge and an ink fountain roller is adjustable. The ink blades are covered by a foil which extends beyond the scraping edges. The foil is folded at an acute angle at an end facing away from the fountain roller. The folded portion rests in a form-locking way in a slot on the upper side of the ink fountain. A form-locking connection is one which connects two elements together due to the shape of the elements themselves, as opposed to a force-locking connection, which locks the elements together by force external to the elements. The ink blades and the foil are disposed at an angle against the circumferential surface of the ink fountain roller. The foil rests tangentially against the ink fountain roller in a region in which the foil extends beyond the scraping edge. The foil is angled towards the ink fountain roller at its end. That angle causes ink droplets that form uncontrollably to be led to the circumferential surface of the ink fountain roller, thus avoiding contamination of the inking unit. The ink fountain can be swiveled away from the ink fountain roller for cleaning purposes and to exchange the foil. When the ink fountain is swiveled back into the operating position after the foil has been changed, there is a risk of the foil hitting the circumferential surface of the ink fountain roller in a radial direction, a fact which might cause the foil to become wavy on the blade or the folded portion to slide out of the slot. In such a case, the ink fountain would have to be swiveled away again and the foil would have to be smoothed across the blade and tucked into the slot between the ink blade and the ink fountain roller by hand. That undesirably extends the required set-up time.

2. Summary of the Invention

It is accordingly an object of the invention to provide an ink metering device for a printing press, which overcomes the hereinafore-mentioned disadvantages of the heretofore-known devices of this general type and which improves handling of an ink fountain foil and reduces a required set-up time.

With the foregoing and other objects in view there is provided, in accordance with the invention, an ink metering device for a printing press. The ink metering device comprises an ink fountain for receiving a supply of printing ink, an ink fountain roller supported in side walls for rotation about an axis of rotation and for dipping into the ink fountain, a plurality of metering elements operating in zones and each having a blade edge disposed at an adjustable distance from a circumferential surface of the ink fountain roller, and at least one foil disposed between the blade edges and the circumferential surface. The at least one foil is fixed to the ink fountain and angled at least at one end along at least one straight line parallel to the axis of rotation. The ink fountain is to be thrown on and thrown off the ink fountain roller between an operating position and an exchange position for exchanging the foil. The foil has a bend or curve causing an end of the foil facing the ink fountain roller, upon being thrown on the ink fountain, to be located substantially tangential to the circumferential surface before reaching the operating position.

In accordance with the invention, an ink foil that is used on an ink fountain to cover metering elements has at least one angled portion or at least one curved section created by deformation. The angled or curved portion causes the foil end facing an ink fountain roller to move almost without resistance into the clearance between the metering elements and the circumferential surface of the ink fountain roller when the fountain roller is swiveled. This ensures that the foil does not move out of its upper mounting or lift off the metering elements in an uncontrolled way when the ink fountain is swiveled back.

A bent or curved portion may be created in the foil by one or more grooving operations or by other deformation processes, in particular mechanical or thermal deformation processes. When a foil with a low degree of torsional stiffness is used, the curving occurs automatically due to the forces of gravity. When a foil of this type is inserted into the ink fountain, the end protruding beyond the blade edges curves on its own account. When the foil is placed in the ink fountain, the end automatically slides through the slot between the metering blade edges and the circumferential surface of the ink fountain roller.

Other features which are considered as characteristic for the invention are set forth in the appended claims.

Although the invention is illustrated and described herein as embodied in an ink metering device of a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, partly-sectional, side-elevational view of a prior art ink fountain in a foil change position;

FIG. 2 is a view similar to FIG. 1 of the prior art ink fountain in an intermediate position;

FIG. 3 is a partly-sectional, side-elevational view of an ink fountain according to the invention in a foil change position;

FIG. 4 is a view similar to FIG. 3 of the ink fountain according to the invention in an intermediate position;

FIG. 5 is a view similar to FIG. 3 of the ink fountain according to the invention in an operating position;

FIG. 6 includes side-elevational views of a profile of a foil having two angled portions;

FIG. 7 includes side-elevational views of a profile of a foil with a circular bent portion; and

FIG. 8 is a partly-sectional, side-elevational view of a further embodiment of an ink fountain according to the invention with a foil including multiple angled portions.

### DETAILED DESCRIPTION OF THE INVENTION

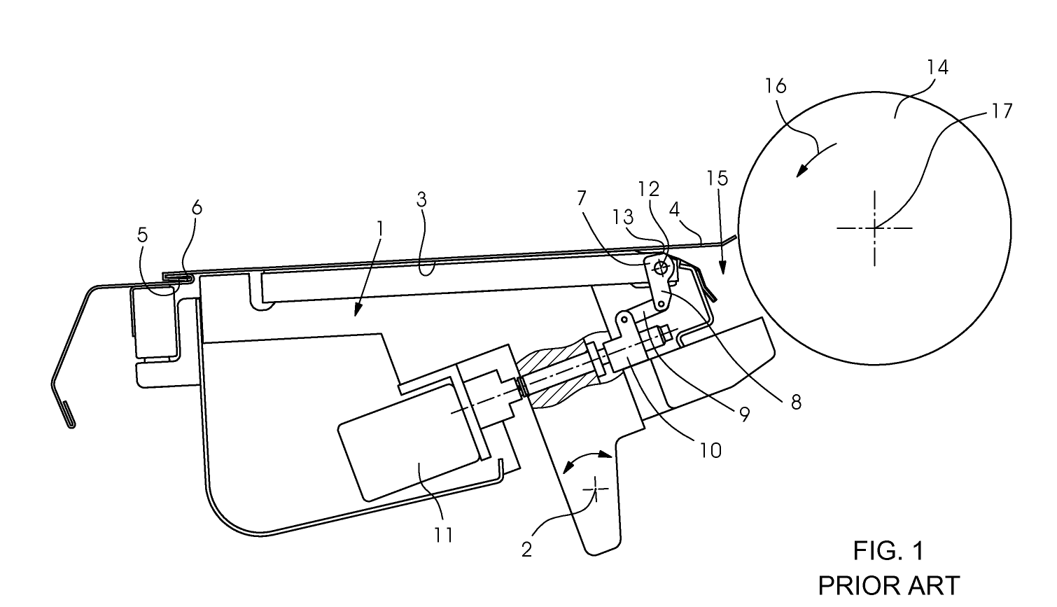

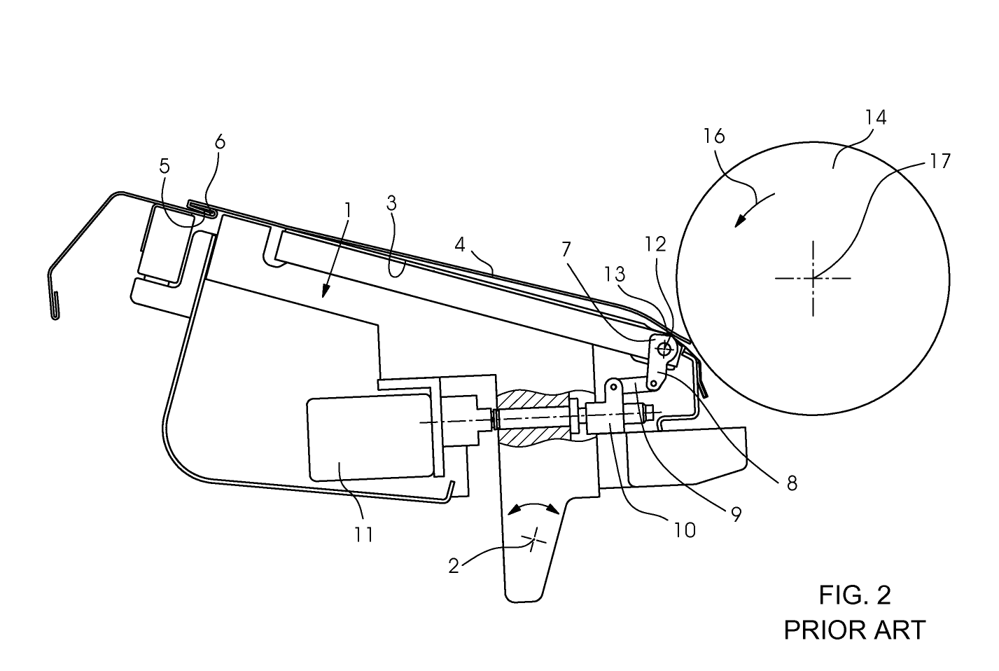

Referring now to the figures of the drawings in detail and first, particularly, to FIGS. 1 and 2 thereof, there is seen an ink fountain 1 according to the prior art in respective foil change and intermediate positions. The ink fountain 1 is supported so as to swivel about an axis 2. A flat support plate 3 for an ink fountain foil 4 is disposed on the ink fountain. The ink fountain foil 4 is angled on one side. An angled portion 5 of the ink fountain foil 4 is located in a retaining slot 6. A plurality of metering elements 7 are provided on the ink fountain 1. Each of these metering elements 7 can be swiveled about an axis 12 through the use of levers 8, 9, a spindle drive 10 and a motor 11. The axis 12 is parallel to the axis 2. A blade edge 13, which is formed on the metering element 7, at the end of the plate 3, is approximately level with a support plane of the plate 3.

When the ink fountain 1 is swiveled away in the foil change position, there is a gap 15 between the ink fountain 1 and an ink fountain roller 14. Once a foil 4 has been inserted into the slot 6, a free angled end of the foil 4 is located above the gap 15 and rests against the circumferential surface of the ink fountain roller 14.

While the ink fountain 1 is being swiveled from the foil change position into the intermediate position shown in FIG. 2, the ink fountain roller 14 rotates between side walls of the printing press about an axis 17 in the direction indicated by an arrow 16. The axis 17 is parallel to the axis 2. Due to the swiveling movement, the width of the gap 15 decreases and the foil 4 is subject to forces which cause it to bulge above the plate 3 as shown. As the ink fountain 1 continues to swivel into an operating position, this bulge does not disappear completely and causes metering inaccuracies and increased foil wear.

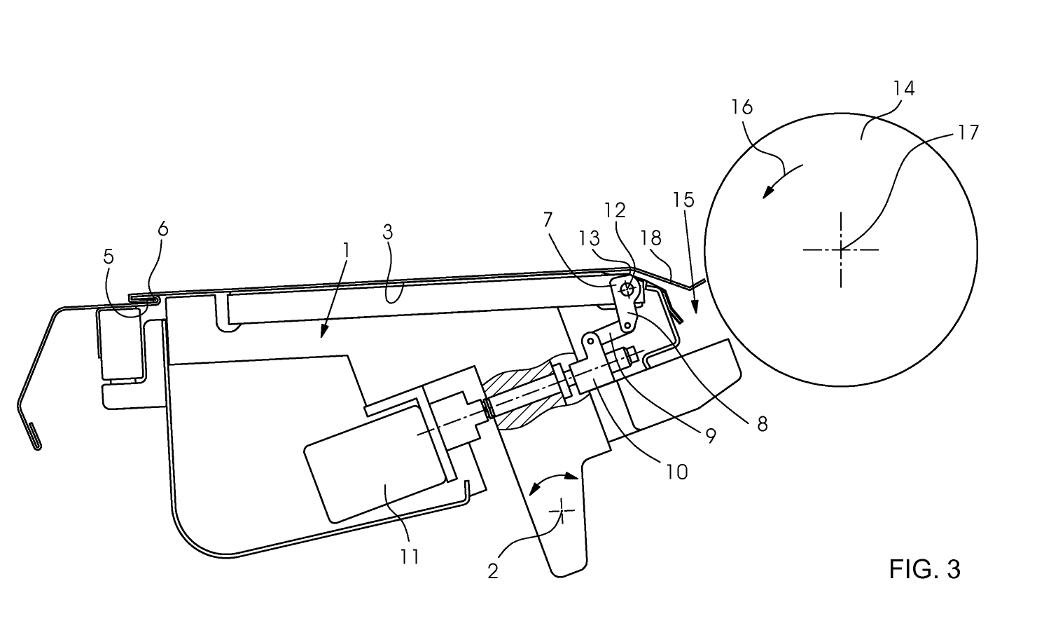

FIGS. 3 to 7 illustrate improved constructions of foils 18, 19 as suggested by the invention.

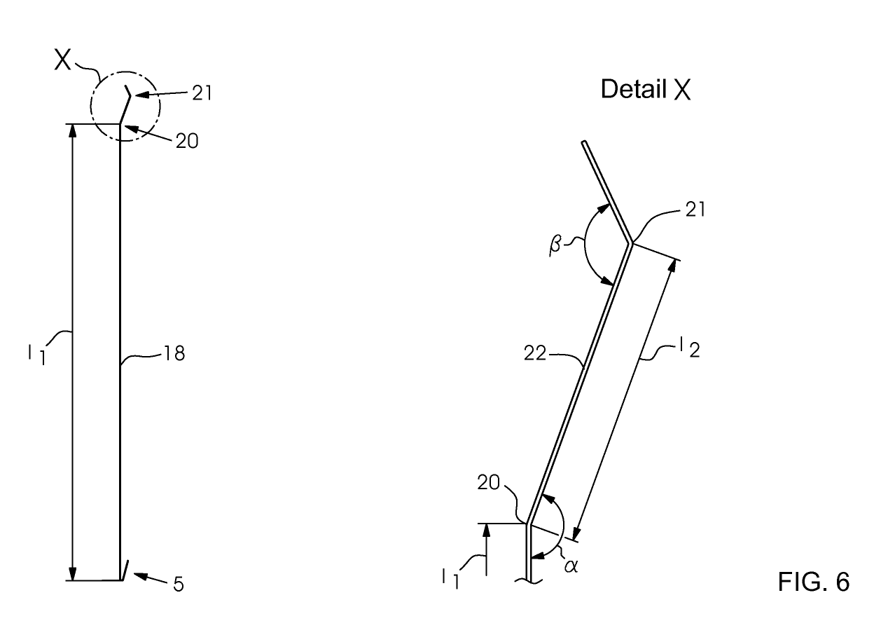

FIGS. 3 to 5 illustrate an ink fountain 1 using a foil 18 shown in FIG. 6. The foil 18 to be used with the ink fountain 1 has a number of deformations: an angled portion 5 to be received in the slot 6, an extended length I₁ substantially corresponding to the width of a plate 3, a further angled portion 20 forming an obtuse angle α, and an end-side angled portion 21 forming an obtuse angle β.

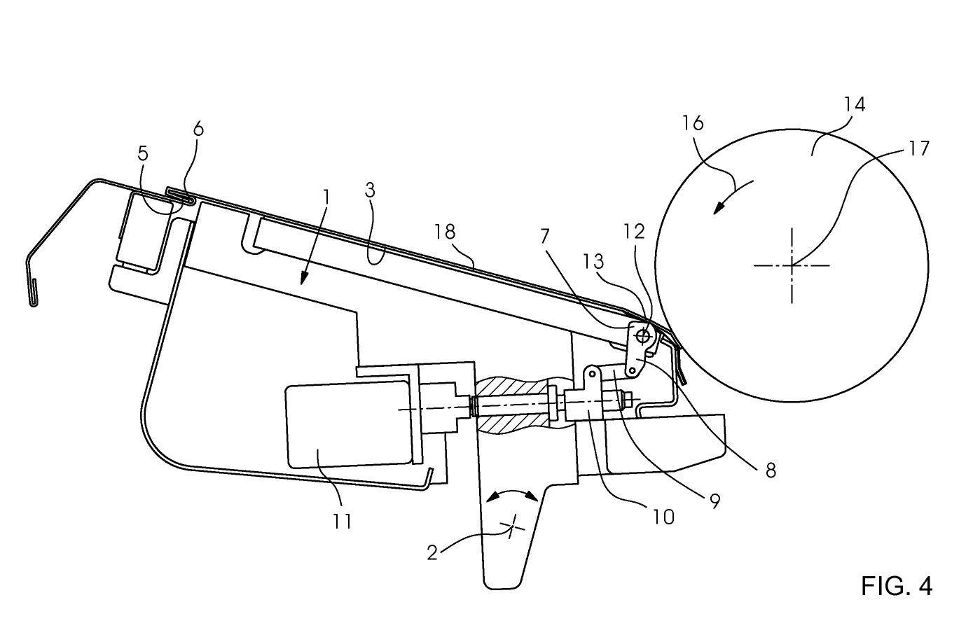

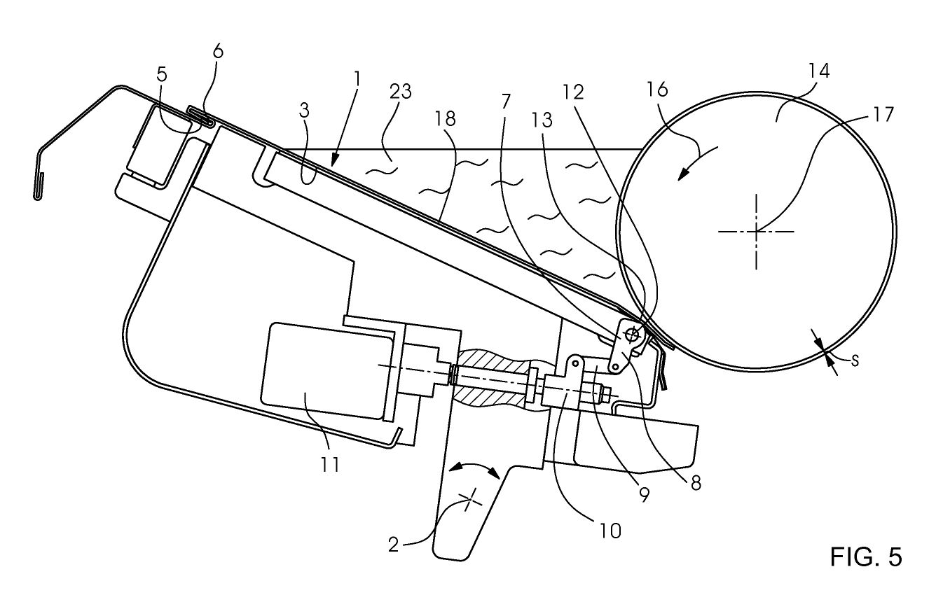

The angled portion, bend or curve 20 causes the foil 18 to project beyond the blade edges 13 into the gap 15 once the foil 18 has been inserted into the gap 6 when the ink fountain 1 is in the foil change or exchange position as illustrated in FIG. 3. An arm 22 having a length I₂ is nearly tangential with the circumferential surface of the ink fountain roller 14. When the ink fountain 1 is swiveled from the change position shown in FIG. 3 into the intermediate position shown in FIG. 4 and further into the operating position shown in FIG. 5, the foil 18 is moved into the gap 15 without positive control and is tautened by contact with the circumferential surface of the ink fountain roller 14. In the operating position, the foil 18 is pressed against the circumferential surface of the ink fountain roller 14 through the use of the metering elements 7. During printing, the metering elements 7 are adjusted about the coaxial axes 12 through the use of the motors 11 in such a way that a desired ink layer thickness s is built up in zones on the circumferential surface of the ink fountain roller 14. Metering of printing ink 23 is not affected by any undesirable deformation of the foil in a metering gap between the metering elements 7 and the circumferential surface of the ink fountain roller 14.

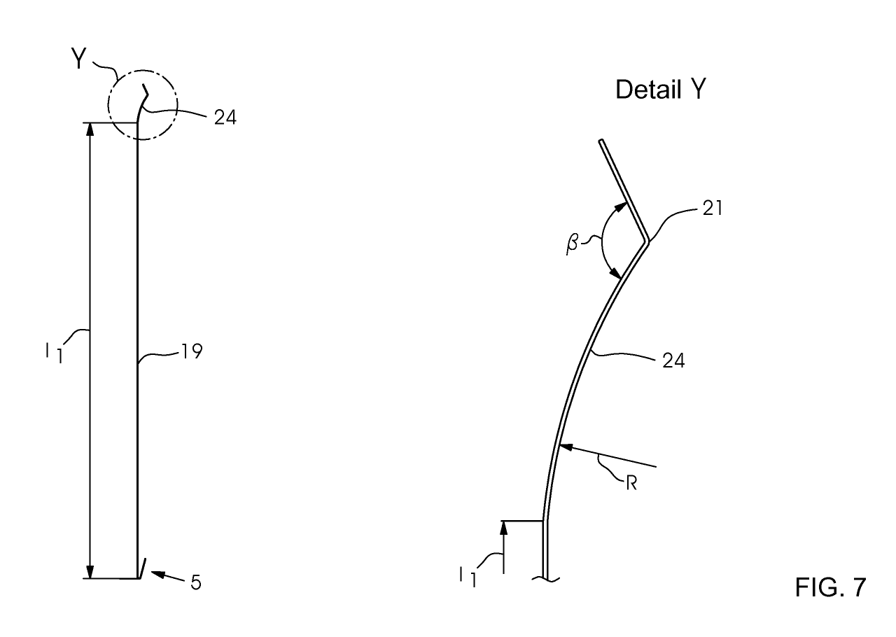

FIG. 7 illustrates an embodiment in which a bent portion, bend or curve 24 having a radius R is formed on an end of a foil 19 instead of an angled portion 20. An arch length of the curved portion 24 approximately corresponds to the length I₂ of the arm 22. The curved portion 24 has the same effect as the angled portion 20.

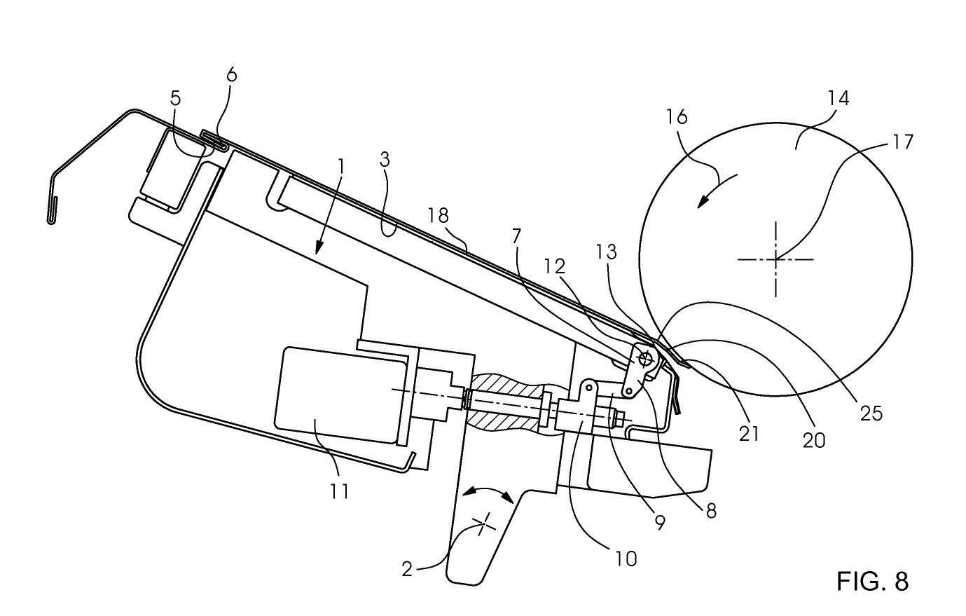

An ink fountain 1 shown in FIG. 8 is equipped with a foil 4 that has multiple folds in a region between the blade edges 13 and the ink fountain roller 14. In addition to the folded portions 20, 21 described in the context of FIG. 6, a further folded portion, bend or curve 25 is formed. The successive folded portions 25, 20 allow the ink fountain to be swiveled without any undesirable deformation of the foil 4.

1. An ink metering device for a printing press, comprising:
an ink fountain for receiving a supply of printing ink;
an ink fountain roller supported in side walls for rotation about an axis of rotation and for dipping into said ink fountain;
a plurality of metering elements operating in zones and each having a blade edge disposed at an adjustable distance from a circumferential surface of said ink fountain roller; and
at least one foil disposed between said blade edges and said circumferential surface, said at least one foil being fixed to said ink fountain and angled at least at one end along at least one straight line parallel to said axis of rotation;
said ink fountain to be thrown on and thrown off said ink fountain roller between an operating position and an exchange position for exchanging said foil;
said foil having a bend causing an end of said foil facing said ink fountain roller, upon being thrown on said ink fountain, to be located substantially tangential to said circumferential surface before reaching said operating position.

2. The ink metering device according to claim 1, wherein said bend is at least one angled portion forming an obtuse angle in a region between said blade edges and said end of said foil.

3. The ink metering device according to claim 2, wherein said angled portion is located adjacent an angled portion located in vicinity of said blade edges.

4. The ink metering device according to claim 2, wherein said angled portion is located adjacent an angled portion located at said end of said foil, and said angled portion located at said end of said foil is directed in a direction opposite to said adjacent angled portion, relative to a plane of said foil.
